(19) United States
(12) Patent Application Publication
(10) Pub. No.: US 2004/0088186 A1
(43) Pub. Date: May 6, 2004

(54) Distributed convergent service control platform

(76) Inventors: Dinesh Kashinath Anvekar, Edison, NJ (US); Bhaskarpillai Gopinath, Topanga, LA (US); Atul Gupta, Piscataway, NJ (US)

Correspondence Address: John T. Peoples, 14 Blue Jay Court, Warren, NJ, 07059, US

(21) Appl. No.: 10/694,935

(22) Filed: Oct. 28, 2003

Related U.S. Application Data
(60) Provisional application No. 60/423,481, filed on Nov. 4, 2002.

(51) Int. Cl. G06F 17/60; H04B 7/185

(52) U.S. Cl. 705/1; 705/400; 455/13.1

(57) ABSTRACT

A common communications services platform, and concomitant methodology, provides communication services to a variety of service operators irrespective of the network media and protocols utilized. The platform is composed of: (1) a plurality of geographically-dispersed convergent services nodes, one of the services nodes serving the service operator; (2) a communications network connected to the nodes; and (3) a database, connected to the communications network, containing information about the service operator, the subscriber, and the communications service provisioned by the platform, the database storing information for at least one of the service nodes to configure the communications service provisioned by the platform.

### CROSS REFERENCE TO RELATED APPLICATION

This application is a non-provisional application of provisional application Serial No. 60/423,481 filed Nov. 4, 2002.

### BACKGROUND OF THE DISCLOSURE

1. Field of the Invention

The present invention relates generally to telecommunications services and, more particularly, to a global distributed services control platform for rapid delivery of services to service operators and subscribers.

2. Background

With advent of the Internet a variety of new telecommunications services can be provided to end-users through application servers spread across the globe. The Internet, traditionally used for data communication applications, is increasingly being used for telephony and telecommunications services. With the modern convergence of voice and data networks, traditional telecom service providers and operators that are tied to legacy environments and legacy services are required to provide new services rapidly and economically. However, in order to provide new services or features to subscribers, telecommunications service operators and service providers typically would require additional equipment such as network bridges and new software to implement the new services or features. This is not a practical solution as each new service or feature involves additional higher cost and time. An alternative approach for a traditional service operator to offer new services to its subscribers is to cooperate with other service operators who can provide the new services or features. For illustration, consider a prior art scenario shown in FIG. 1. Service operator-A 100 provides a certain service to subscribers 110 via network-A 120, and service operator-B 130 provides a different service to subscribers 150 via network-A 140. The media and protocols used over the networks A and B could be quite different and incompatible. For example, service operator-A could be a wireless phone service operator for subscribers with indoor wireless communication devices such as PDA (Personal Digital Assistant), Bluetooth devices, and WiFi devices, and service operator-B could be Internet service provider with subscribers using laptops and PCs. If now, the service operator-A 100 needs to provide to its subscribers some of the services provided by service operator-B 130, then a bridge between service operators A and B through network-C 160 needs to be created. In general, it is possible that the communication medium and protocol used over network-C 160 is different from those used over networks A and B (120 and 140). The bridging between service operators A and B (100 and 130) may also require suitable network interfaces (e.g., network bridge 101) to be newly installed and also development of new protocol bridging software (e.g., 102). Also, the providing of value added services by service operator-B 130 to service operator-A 100 may involve external application servers 170 that can communicate via network-C 160. Thus, providing newer services to subscribers by service operator-A involves additional cost and time. Moreover, if service operator-A 100 wants to provide its subscribers other value added features by utilizing the services from other service operators then for each service operator providing a service, service operator-A 100 will incur additional cost for the network bridging interface (such as 101) and protocol software (such as 102). Such a solution is therefore not attractive in the current telecom scenario wherein there is an ever-increasing demand for new features and services. Therefore, there is now a need for a common communications services platform that can provide communication services to a variety of service operators irrespective of the network media and protocols they use. Such a global services platform is described in the present invention.

U.S. patent application publication Ser. No. 2002/0,052,754 A1 pertains to a convergent communications platform and method for mobile and electronic commerce in a heterogeneous network environment. Specifically, the invention relates to a convergent communications system that provides mobile and electronic commerce and communication services through existing communication switches without specific hardware located at those switches. An embodiment of the invention is a convergent communication system that resides in a centralized location. An aspect of the invention involves apparatus and method for providing pre-paid roaming communication services via a plurality of networks. Other aspects of the invention include methods of providing customer care services, recharging a pre-paid account, and settling a pre-paid transaction to a plurality of providers in a convergent communications environment. Even though the invention involves convergence of communication means to provide electronics commerce, it does not involve distributed control of services in a geographically distributed platform with the use of service monitors and program units such a described in our invention.

A service architecture for the rapid development of next generation telephony services that overcome the limitations of the current closed PSTN architecture and service model is described in U.S. patent application publication Ser. No. 2001/0,028,654 A1. Services in this architecture are provided by multiple cooperating distributed service providers. The invention basically involves a method and system for activating additional services from one or more independent service providers whiles telephone communication is being established or is already in progress between a calling party and a called party. In comparison, our invention involves a generalized services system with a plurality of service control nodes and service monitors.

U.S. patent application publication Ser. No. 2002/0,055,995 A1 describes a global service management system for use in an advanced intelligent network. The system is adapted to communicate with two or more network element managers servicing SCPs (Service Control Points) and operating pursuant to different protocols. The invention is aimed at solving the problem of protocol disparity among network element managers of different SCPs in an advanced intelligent network. Even though the problem of protocol disparity is addressed like in our invention, this invention does not involve service monitors with distributed service control nodes.

U.S. patent application publication Ser. No. 2001/0,013,001 A1 describes a web-based platform for interactive voice response (IVR). The speech synthesizer, grammar generator, speech recognizer and other elements of the platform may be operated by an Internet service provider, thereby allowing the general Internet population to create interactive voice response applications without acquiring their own IVR equipment. While the invention embodies a solution for providing IVR services to users without IVR equipment, it does not involve convergence of different communication services at a common platform as in our invention.

U.S. Pat. No. 6,289,201 B1 pertains to a communication system and method to enable service management in a global network environment including independent virtual networks. Specifically, this invention relates to a method and system for multi-layer service management in a satellite communication system. Distributed services management is achieved in this invention by way of satellite communications. While the invention involves a distributed application platform for building and executing network wide applications it does not pertain to providing services to existing service operators through a convergent communications platform as in our invention.

### SUMMARY OF THE INVENTION

These shortcomings and other limitations and deficiencies are obviated in accordance with the present invention by a common communications services platform system, and concomitant methodology, provides communication services to a variety of service operators irrespective of the network media and protocols utilized.

In accordance with a broad system aspect of the present invention, a convergent service control platform for provisioning a communications service as requested by a service operator for a subscriber served by the operator includes: (1) a plurality of geographically-dispersed convergent services nodes, one of the services nodes serving the service operator; (b) a communications network connected to the nodes; and (c) a database, connected to the communications network, containing information about the service operator, the subscriber, and the communications service provisioned by the platform, the database storing information for at least one of the service nodes to configure the communications service provisioned by the platform.

Broad method aspects of the present invention are commensurate with the aforementioned broad system aspects.

### BRIEF DESCRIPTION OF THE DRAWINGS

The teachings of the present invention can be readily understood by considering the following detailed description in conjunction with the accompanying drawings, in which:

FIG. 1 is a high-level block diagram of a prior art system to provide additional customer services;

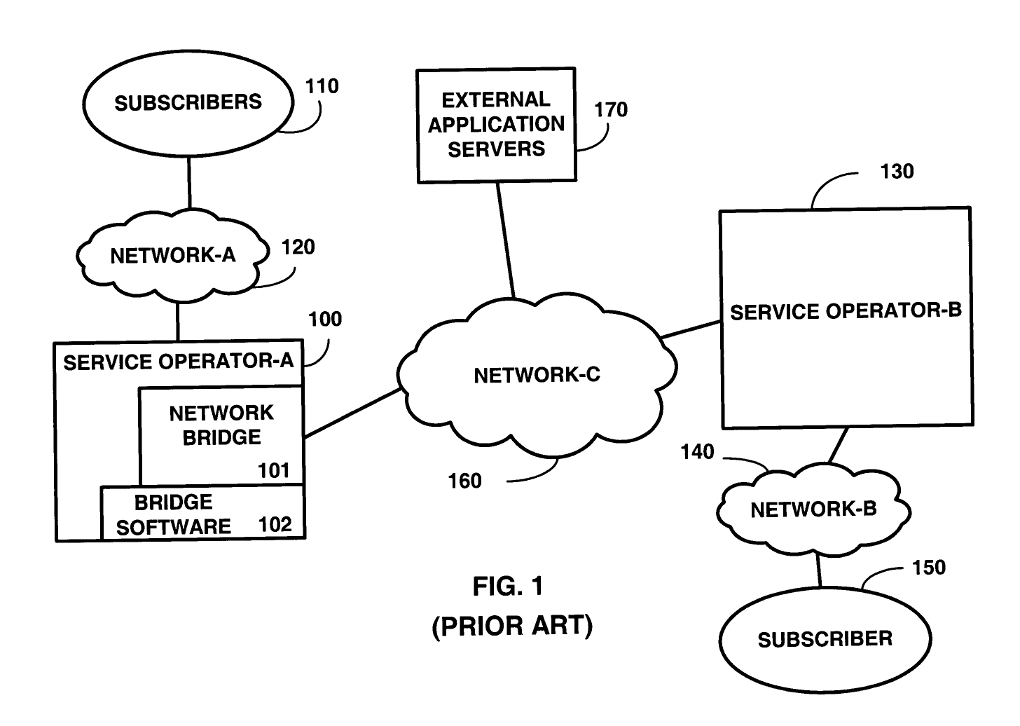

FIG. 2 is a high-level block diagram of a distributed convergent services platform in accordance with the present invention to provide new services and features to subscribers;

FIG. 3 is a high-level block diagram depicting the components of a convergent service node;

FIG. 4 depicts exemplary service transaction records for the node database of FIG. 3;

FIG. 5 depicts exemplary service records stored in the central database of FIG. 2;

FIG. 6 depicts exemplary service profile records stored in the central database of FIG. 2;

FIG. 7 depicts exemplary service monitors records stored in the service monitor of FIG. 3;

FIG. 8 depicts a flow diagram showing the service creation process for the distributed convergent service control platform of FIG. 2;

FIG. 9 depicts a relational diagram of an instance of providing service through the platform of FIG. 2;

FIG. 10 depicts a flow diagram showing the providing of service through the distributed convergent service control platform of FIG. 2;

FIG. 11A illustrates the process of copying convergent service pack information by a convergent service node;

FIG. 11B illustrates the technique for synchronizing two convergent service nodes and the central database of FIG. 2 with the convergent service pack information with respect to discrete points of time.

To facilitate understanding, identical reference numerals have been used, where possible, to designate identical elements that are common to the figures.

### DETAILED DESCRIPTION

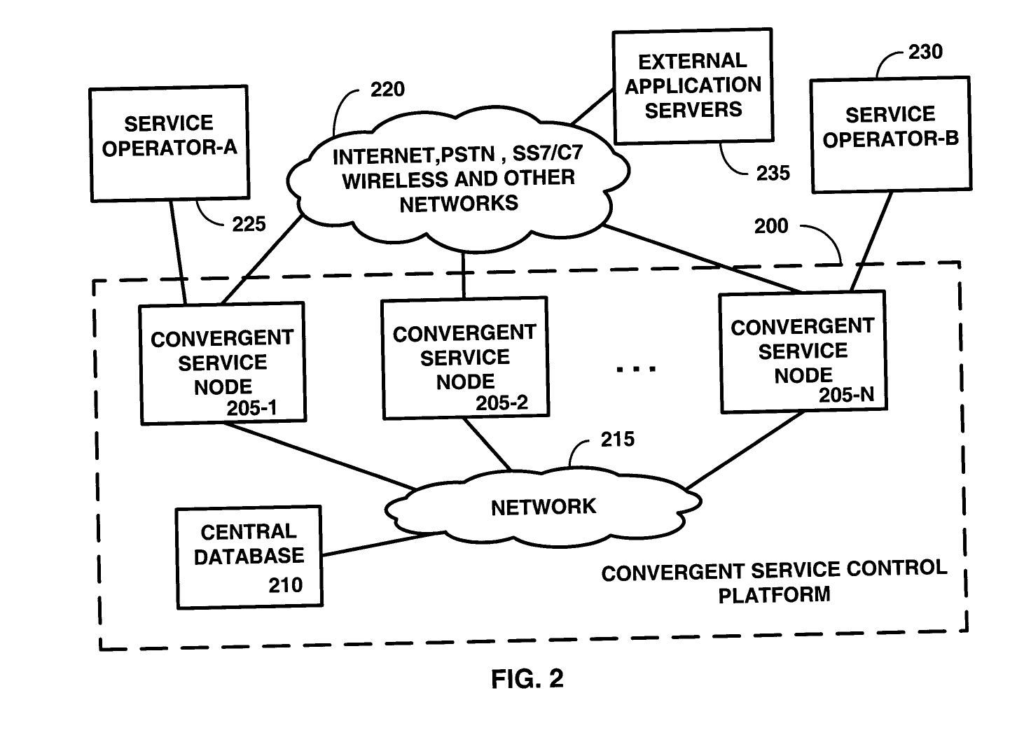

A preferred embodiment of the present invention is a convergent service control platform shown schematically in FIG. 2. The convergent service control platform 200 comprises a plurality of convergent service nodes (CSNs) (205-1 . . . 205-N, collectively 205) that are capable of communicating with each other through a high-speed communications network 215. In practice, convergent service nodes 205 are located at geographically different locations spread across the world to provide convenient short distance connectivity for service operators (e.g., 225 and 230). The convergent service nodes 205 are also capable of communication with each other via the Internet, PSTN, SS7/C7, wireless network and other networks (220). Also, the convergent service nodes (205) can communicate with external application servers 235 via the network cloud 220 comprising the Internet, PSTN, SS7/C7, wireless network and other types of networks. A service operator (225,230) that requires services provided through the convergent services control platform 200 is linked preferably to the closest CSN via a suitable communication bridge in the node (e.g., node 205-1, discussed below). With the link thus established, a service operator can be provided a variety of new services by the convergent service control platform 200 by utilizing application servers within any CSN of the platform or application servers located at any external site accessible by the platform. The convergent service control platform includes a central database 210 that contains information about service operators and subscribers, and services that can be provided by the platform. Profiles of service operators and subscribers are stored in the database 210. While the database 210 has been shown in FIG. 2 as a single entity located in one place, it can in general be distributed over memories of computers located at different geographical locations, but data consistency in maintained by avoiding multiple copies of the same data.

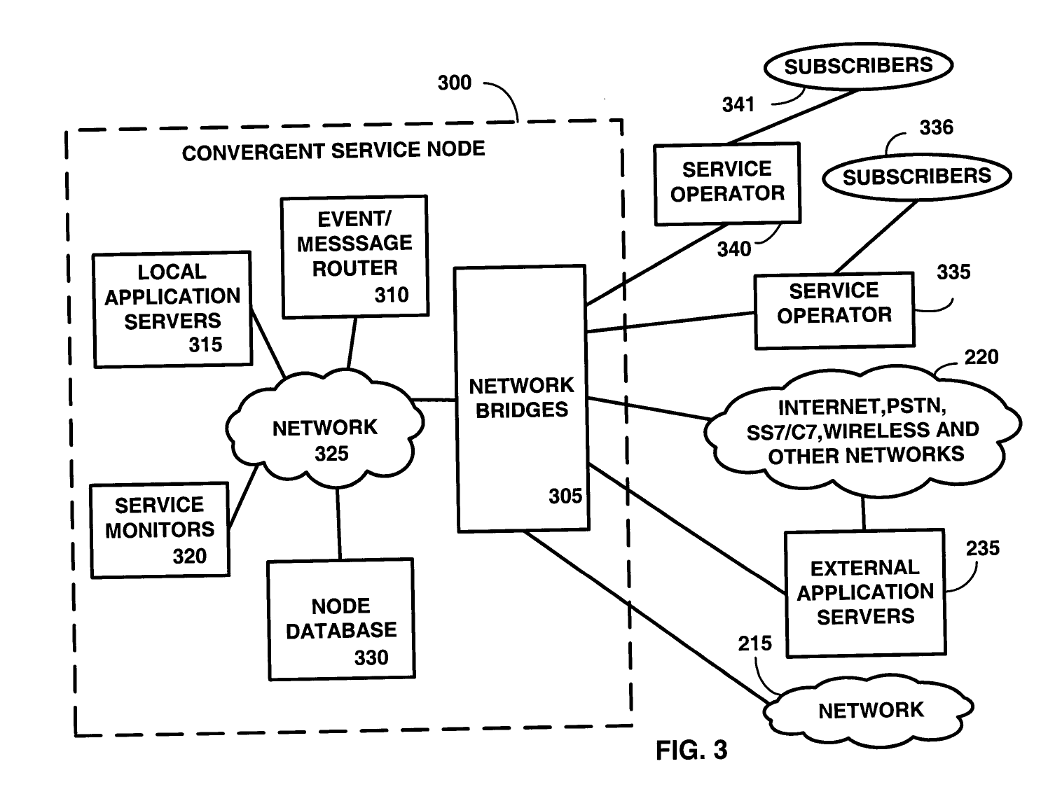

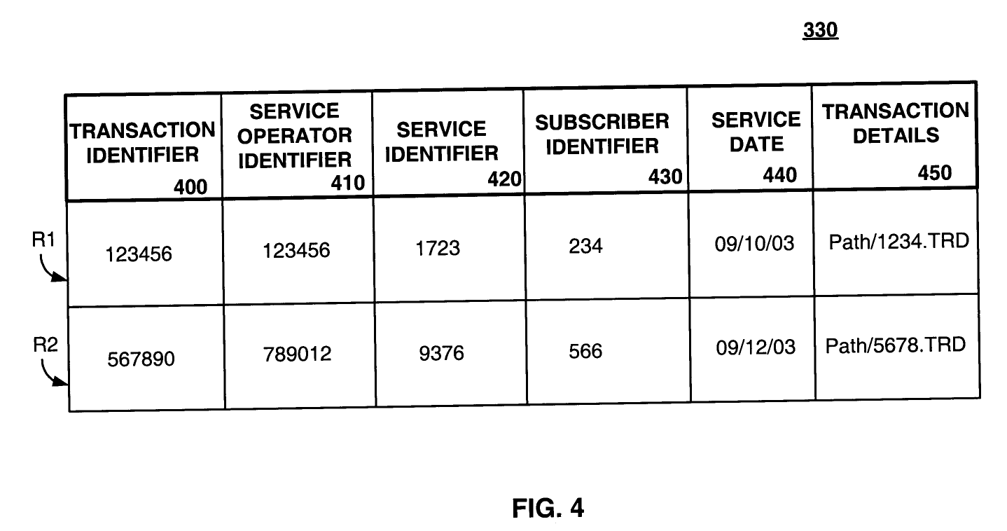

A schematic representation of a convergent service node 300 is shown in FIG. 3. The major components of a CSN include a set of network bridges 305, an event/message router 310, a set of local application servers 315, service monitors 320, a node database 330, and a network 325 connecting the above-mentioned entities. The network bridges 305 are used to interface with service operators (e.g., 335 and 340), network 215 of the convergent service control platform 200, external application severs 235, and network cloud 220 including the Internet, PSTN, SS7/C7, wireless and other networks. By way of example and not limitation, typical bridges include TCP bridge/adapter, SMTP bridge, PSTN bridge, CAS/ISDN signaler, PSTN/IP bridge, SMPP bridge/gateway, UCP bridge/gateway, HTTP bridge, and SIP signaler that are well known to those skilled in the art. Communication with external entities takes place through the network bridges 305. Service requests sent by service operators (e.g., 335 and 340) are received by the event/message router 310 via the network bridges 305 through the local network 325. For convenience and efficiency of operation, the communication among the different entities of a CSN 300 takes place through a common format and language such as for example the XML (Extensible Mark-up Language). The bridges 305 convert service requests and other information received from service operators into the common format and language before sending them to the event/message router. The local application servers 315 hold program units that perform specific tasks. Providing a service in response to a service request generally involves one or more program units to function in a cooperative manner. Service Monitors 320 are special program units that coordinate and manage all program units working together to provide a service. Information about services necessary for the functioning of the program units and service monitors and transactions regarding services provided are stored in the node database 330. Much of the information in the node database 330 is created by copying the relevant records from the central database 210 which are described later. Data consistency between the central database 210 and the node database 330 is maintained by periodic synchronization. While the central database 210 provides a unified storage for data related to all services and service operators of the platform 200, the copied portions of data in the node database 330 are useful for fast retrieval locally and usage during the time a service is provided. Another component of the node database 330 includes the service transaction records as exemplified in FIG. 4. Relevant details of node database 330 and central database 210 are described now.

The rows and columns of the databases described herein represent records and fields thereof, respectively. In the described embodiments, the databases are used in a relational arrangement, as is known in the art, so that the databases relate to one another by way of fields that store common data. It is to be noted that while the following description refers to specific individual databases, formats, records, and fields, those skilled in the art will readily appreciate that various modifications and substitutions may be made thereto without departing from the spirit and scope of the present invention.

Referring now to FIG. 4 an embodiment of node database 330 is shown with service transaction records depicted in detail. For exemplary purposes, two records R1 and R2 are shown. Field 400 stores a transaction identifier that is associated with and that uniquely identifies a usage of a service by a subscriber. Fields 410, 420, and 430 are used to store the service operator identifier, service identifier, and subscriber identifier respectively. The numbers of digits in the fields 400-430 are shown only for exemplary purpose and can be fixed depending on the practical requirements of an implementation of the system. The date of transaction stored in field 440 in conjunction with transaction identifier uniquely identifies a transaction. Field 450 stores a pointer to the file that stores the details of the transaction. The keyword ‘Path’ indicated in field 450 refers to the server and directory path in the server where the transaction details file (e.g., 1234.TRD) can be located. A transaction details file contains relevant information about the service based on which subscriber service reports and bills can be produced.

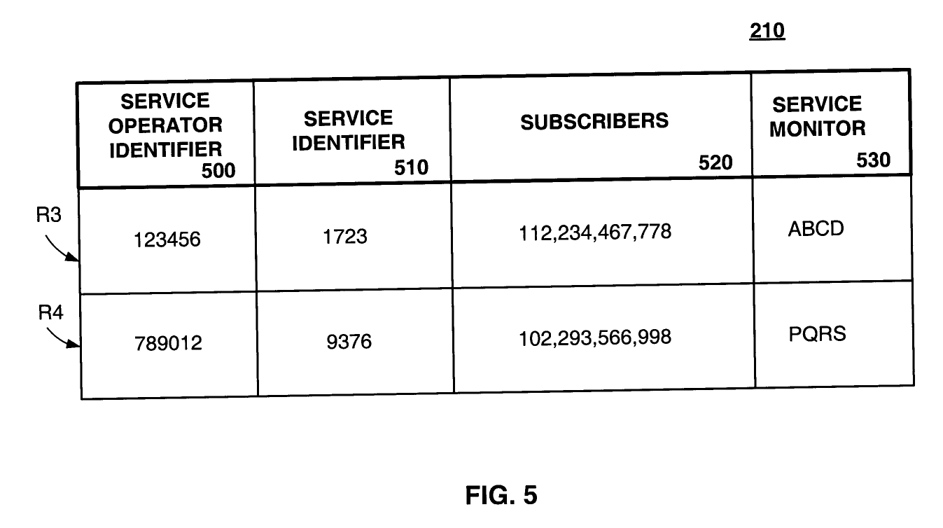

As already mentioned, the node database 330 comprises information copied from the central database 210, and as such, the following description with regard to central database 210 with FIGS. 5, 6, and 7 also applies to the node database 330.

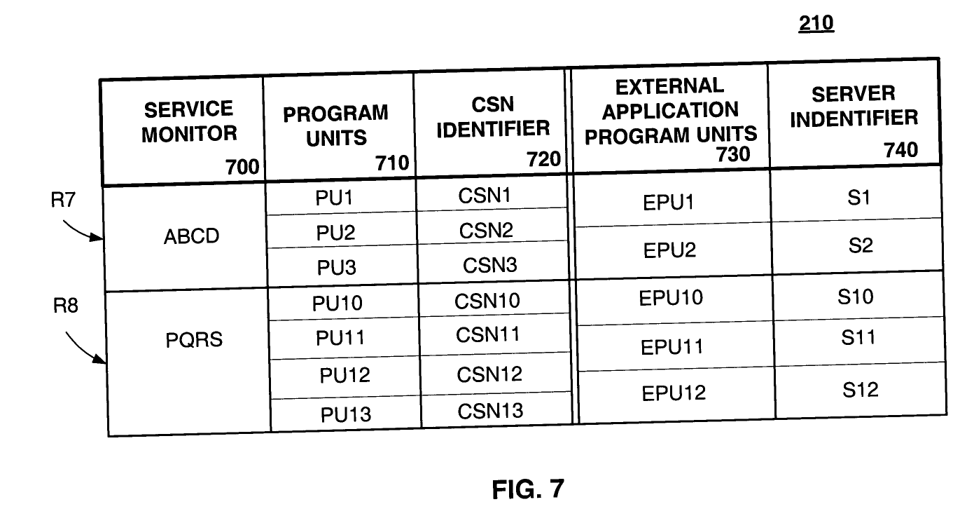

Referring next to FIG. 5, an embodiment of central database 210 is shown with service records depicted in detail. Service records of database 210 store data relating to one or more services. One record (row) is maintained for each service. For exemplary purposes, two records R3 and R4 are shown. Field 500 stores a service operator identifier that uniquely identifies a service operator. Field 510 is used to store a service identifier that identifies a service being offered to the subscribers of the service operator. Field 520 stores identifiers of subscribers that have subscribed to the service indicated in field 510. Field 530 stores the name of the service monitor used to offer the service. More details of service monitors are given in service monitor records that will be described later with reference to FIG. 7.

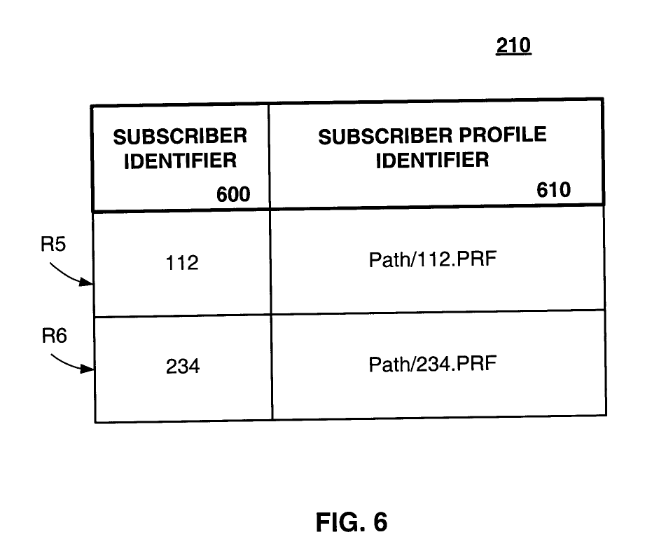

Referring next to FIG. 6, an embodiment of central database 210 is shown with service profile records depicted in detail. For exemplary purposes, two records R5 and R6 are shown. A subscriber identifier is stored in field 600 and a pointer to the file storing the subscriber's profile is given in field 610. The keyword ‘Path’ indicated in the field 610 refers to the server and directory path in the server where the subscriber profile file (e.g., 112.PRF) can be located. The information contained in the subscriber profile file is useful for providing a service to the subscriber and optimizing resources and costs involved in providing the service.

Referring next to FIG. 7, an embodiment of central database 210 is shown with service monitor records depicted in detail. For exemplary purposes, two records R7 and R8 are shown. A service monitor identifier is stored in field 700. Field 710 stores identifiers of program units that are invoked by the service monitor indicated in field 700 and the respective CSNs where the program units are located are stored in field 720. A service monitor may invoke program units residing in servers external to the platform 200, and such external application program units are identified in field 730 with the respective servers indicated in field 740. It is noted that while alphanumeric abbreviations are indicated in fields 700-740, in practice, identifiers involving file path names and Internet URLs are generally used.

### Service Creation

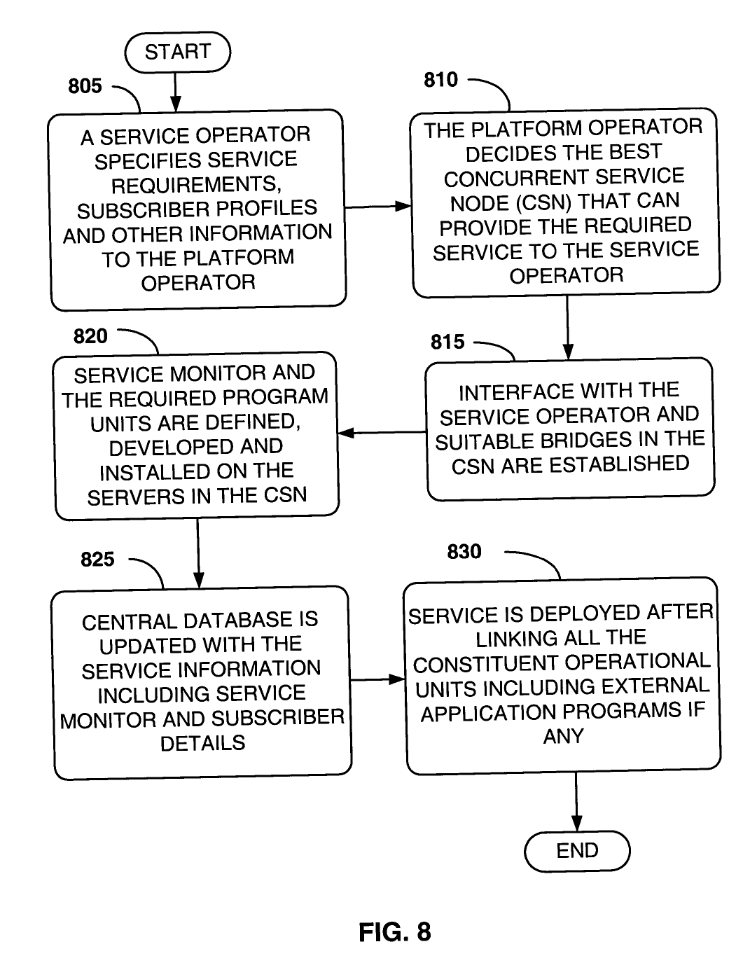

A schematic flow diagram showing the service creation process is shown in FIG. 8, including the following processes.

Process 805: A service on the platform 200 is created based on the specifications given by a service operator. Basically, a service operator specifies service requirements, subscriber profiles and other information to the platform operator. In order to simplify service specification and implementation, a set of service templates involving basic service functions are provided by the platform operator. Also, a suitable format and language is defined for service requirements specification. For example, XML service functions templates could be provided and other non-template specification would be required to be provided using XML.

Process 810: Based on the service requirements, the platform operator decides the best concurrent service node(s) that can provide the required service to the service operator. It is possible that depending on the service constraints and features, more than one CSN may be configured to provide the service. For example, depending on the time of providing a service through the platform 200, it may be economically beneficial to have the service functions performed in CSNs located in different time zones across the globe. In such a case, a service monitor is programmed to switch to appropriate program units in other CSNs.

Process 815: Communication links between the service operator's existing set-up and the platform 200 through suitable interface hardware and bridges in the CSN(s) are established.

Process 820: Based on the service specifications provided by the service operator, an appropriate service monitor and the required program units are defined, developed and installed on the servers in the CSN(s). If the service specifications are already in the known format (e.g., XML) and service templates have been used, then it is possible that many of the installation processes for service monitor and program units could be performed through automated program development processes.

Process 825: The central database 210 is updated with the service information including service monitor and subscriber details such as shown in FIGS. 5, 6, and 7.

Process 830: With all the constituent modules of a service installed on the servers in CSN(s), a service is deployed after linking all the constituent operational units including external application programs if any.

### Platform Operation

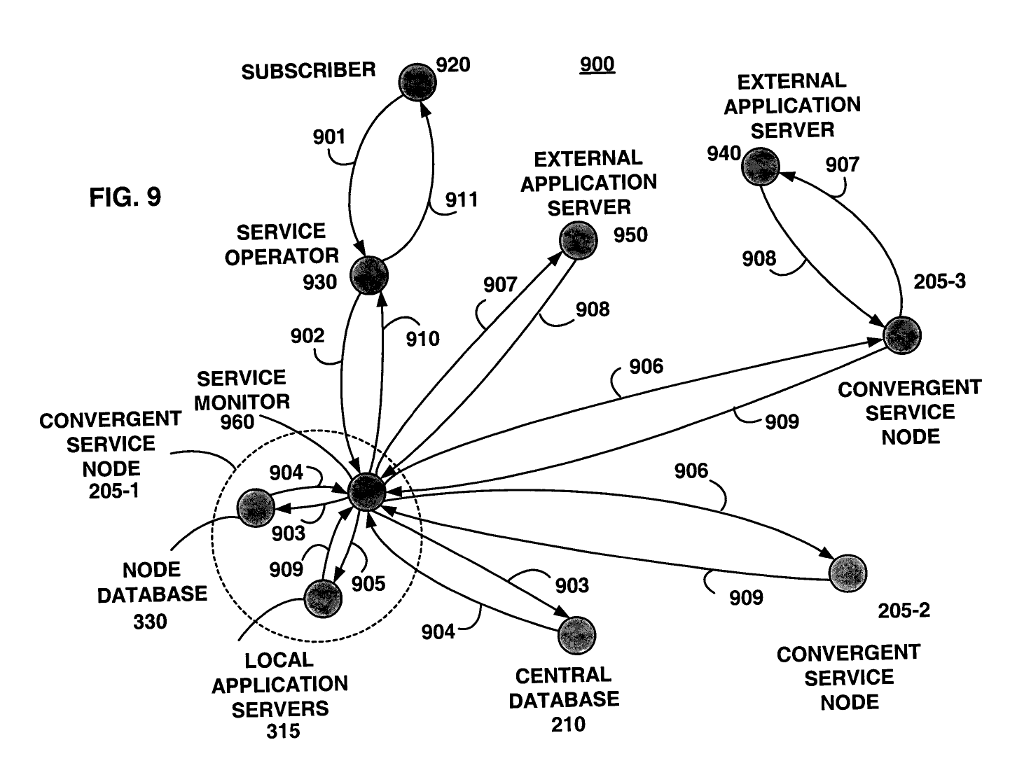

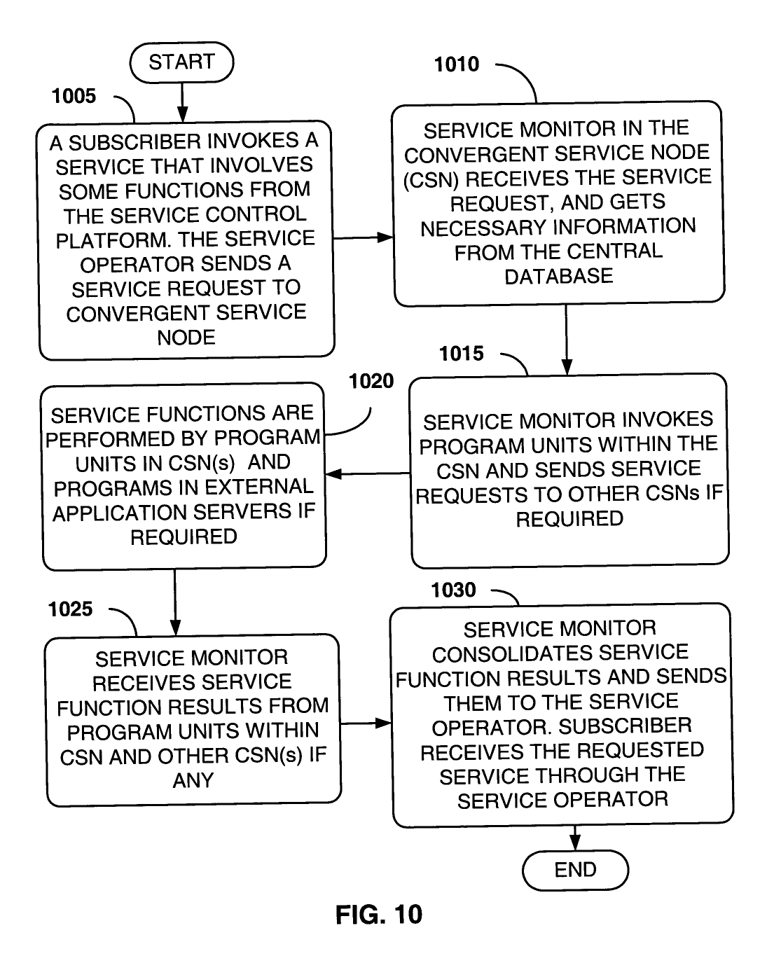

FIG. 9 depicts a relational diagram 900 useful in understanding an embodiment of the invention. Specifically, the relational diagram 900 depicts an instance of providing service through the platform 200. Also, the diagram 900 is helpful in understanding the temporal interactions among the different functional elements depicted in FIG. 2. The interactions of FIG. 9 are indicated along with the description of FIG. 10 that depicts a flow diagram showing the providing of service through the platform 200, involving the following processes.

Process 1005: A subscriber invokes 901 a service that involves some functions from the service control platform. The service operator finds from the requested service that to provide that service some functions or features need to be performed with the help of the convergent services control platform 200. Accordingly, the service operator sends 902 a service request to the convergent service node 205-1 in the required service request format.

Process 1010: The service request is received through a bridge in the CSN 205-1 and routed to the appropriate service monitor 960. The service monitor then accesses 903 the node database 330, and central database 210, if required, and gets 904 the relevant service and subscriber related information. Process 1015: Service monitor 960 invokes 905 program units in the local application servers 315 of the CSN 205-1 and sends 906 service requests to other CSNs (e.g., 205-2, 205-3), if required.

Process 1020: Program units in CSN(s) perform the required service functions. It is possible that some service functions may have to be completed by utilizing external application servers (e.g., 940,950). In that case, monitor programs within some CSNs (e.g., 205-1,205-3) send 907 service requests to external application servers and receive 908 the results.

Process 1025: The service monitor 960 receives 909 service function results from program units within CSN 205-1 and other CSN(s) (e.g., 205-2,205-3), if any.

Process 1030: The service monitor 960 consolidates service function results and sends 910 them to the service operator 930. The subscriber 920 then receives 911 the requested service through the service operator 930.

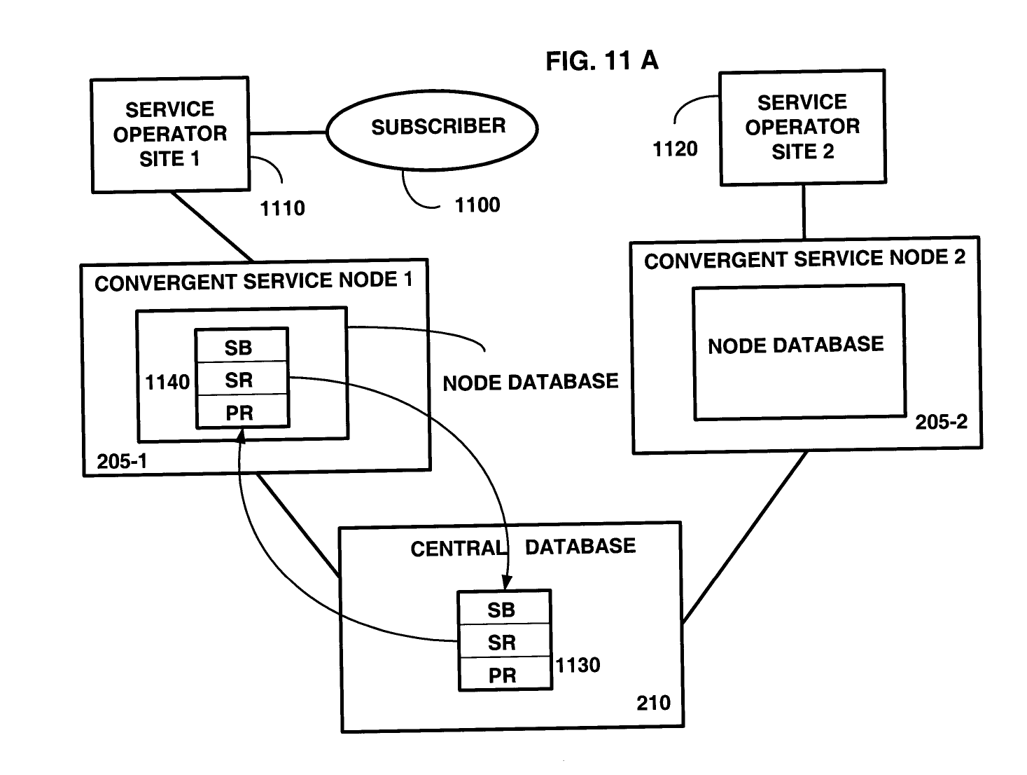

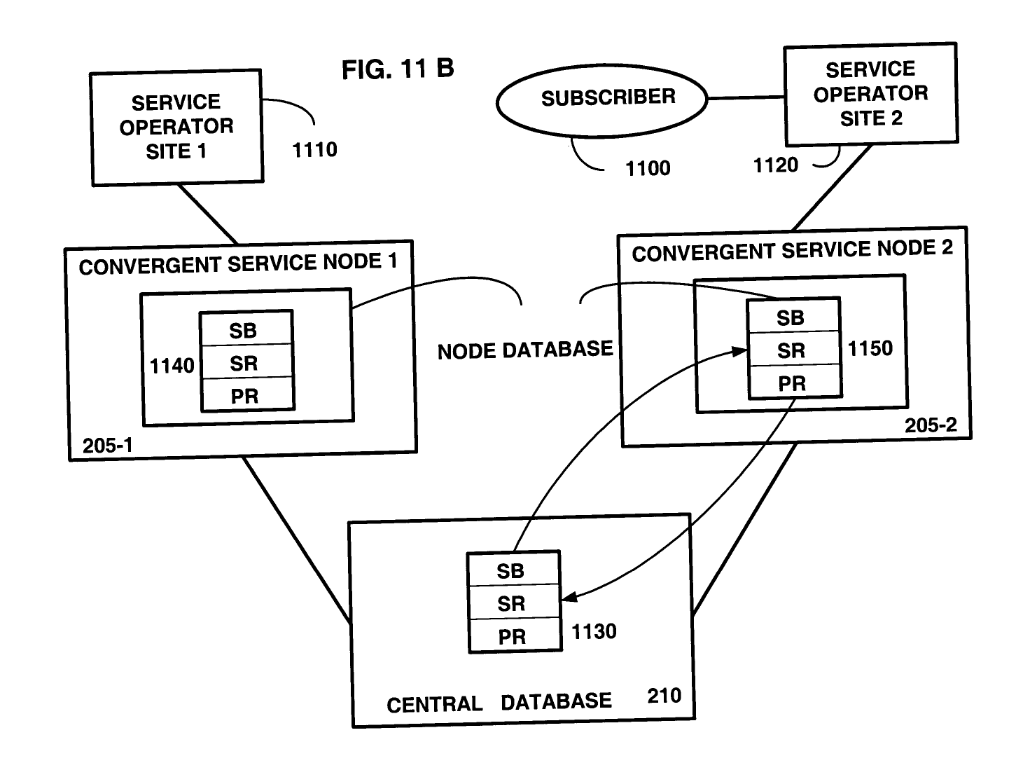

A distinguishing embodiment of the invention is the method of keeping the information about the subscriber, service and the particular category of service as a package within the central database. A given communication service can have different sub-categories called products. For example, an SMS service could have two products—product 1 with limited number of short messages per day and product 2 with no limit on the number of SMS messages. In the central database, the information about the subscriber, service and the product are logically considered as a group—Convergent Service Pack (CSP). A subscriber may utilize the service through any convergent service node of the system, but still the context of service is maintained the same by copying the CSP information. FIG. 11-A illustrates the process of copying the CSP information by a CSN. The subscriber 1100 utilizes the service through the service operator site 1 (1110) and CSN 205-1. During this time, the subscriber information (SB), service information (SR) and the product information (PR) as a group CSP 1130 is copied as an instance CSP 1140 in the node database of CSN 205-1. If allowed, the subscriber may change some of the information in the CSP 1140. After the subscriber has completed utilizing the service, the CSP 1130 is later updated in the central database 210. It may be noted that at this stage the CSN 205-2 does not have any information about the subscriber and the service. FIG. 11-B illustrates the technique for synchronizing two convergent service nodes and the central database of FIG. 2 with the convergent service pack information with respect to discrete points of time. Referring to FIG. 11-B, suppose at a later time the subscriber 1100 requests for the service through a different service operator site 2 (1120). The corresponding CSN 205-2 then gets the CSP information into its node database as an instance CSP 1150. Because the CSP information is thus copied, the subscriber gets the same service context as earlier. Again, any changes to the CSP 1150 during this service utilization will be updated in the central database 210 at a later time when the subscriber has completed utilizing the service through CSN 205-2. Thus the node databases in the CSNs and the central database 210 are synchronized with reference to their data at discrete points of time.

### Application Example

Consider a cell-phone user getting phone service from a regular cellular service provider. If the cellular service provider now wants to provide teleconferencing service, then a teleconferencing application interface is created with the convergent service control platform. Then, the cell-phone user is directed by the service provider to a convergent service node for utilizing the teleconferencing service. The user then can create his/her profile that contains among other details, contact information about teleconference participants. At a later point of time, the user can initiate a teleconference through any CSN of the system. The CSN then extracts the participants' telephone numbers from the profile of the user stored in the central database and initiates a teleconference service monitor in the CSN. The teleconference service monitor then coordinates the conduction of the teleconference among the chosen members.

Although the embodiments of the present invention have been shown and described in detail herein, those skilled in the art can readily devise many other varied embodiments that still incorporate these teachings. Thus, the previous description merely illustrates the principles of the invention. It will thus be appreciated that those with ordinary skill in the art will be able to devise various arrangements, which although not explicitly described or shown herein, embody principles of the invention and are included within its spirit and cope. Furthermore, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, that is, any elements developed that perform the function, regardless of structure.

In addition, it will be appreciated by those with ordinary skill in the art that the block diagrams herein represent conceptual views of illustrative circuitry, equipment, and systems embodying the principles of the invention.

What is claimed is:

1. A convergent service control platform for provisioning a communications service as requested by a service operator for a subscriber served by the operator, the platform comprising
a plurality of geographically-dispersed convergent services nodes, one of the services nodes serving the service operator,
a communications network connected to the nodes, and
a database, connected to the communications network, containing information about the service operator, the subscriber, and the communications service provisioned by the platform, the database storing information for at least one of the service nodes to configure the communications service provisioned by the platform.

2. The platform as recited in claim 1 wherein the database is a central database.

3. The platform as recited in claim 1 wherein the database is distributed with data consistency maintained by precluding multiple copies of the same data.

4. The platform as recited in claim 1 wherein the communications service is provisioned by one of the convergent services nodes distinct from the one serving the operator.

5. The platform as recited in claim 1 wherein the communications network is a proprietary network.

6. The platform as recited in claim 1 wherein the convergent services nodes are also connected via conventional networks, including the Internet, the public switched telephone network, the SS7 signaling network, and the wireless network.

7. The platform as recited in claim 6 further including an external application server wherein the communications service utilizes the external application server and is accessible to the operator via the convergent services nodes in conjunction with the conventional networks.

8. The platform recited in claim 6 wherein the communications network is distinct from the conventional networks.

9. The system recited in claim 1 wherein each of the convergent service nodes comprises
a local network,
a network bridge, coupled to the communications network and the local network, for supporting a plurality of communication protocols
an application server, coupled to the local network, having an application program to configure the communications service whenever the communications service is provisioned by one of said convergent service nodes,
a node database, coupled to the local network, storing information about the service operator, the subscriber, and the communication service whenever the communications service is provisioned by one of said convergent service nodes,
a service monitor, coupled to the local network, for monitoring the communication service whenever the communications service is provisioned by one of said convergent service nodes, and
a router, coupled to the local network, for passing messages and event notifications via the local network to the local application, the service monitor, the node database, and the network bridge.

10. A convergent service control platform for concurrently provisioning a plurality of communications services as requested by a service operator for a subscriber served by the operator, the platform comprising
a plurality of geographically-dispersed convergent services nodes, one of the services nodes serving the service operator,
a communications network connected to the nodes, and
a database, connected to the communications network, containing information about the service operator, the subscriber, and the communications services provisioned by the platform, the database storing information for at least one of the service nodes to configure the communications services provisioned by the platform.

11. The platform as recited in claim 10 wherein the database is a central database.

12. The platform as recited in claim 10 wherein the database is distributed with data consistency maintained by precluding multiple copies of the same data.

13. The platform as recited in claim 10 wherein the communications services are provisioned by at least one of the convergent services nodes distinct from the one serving the operator.

14. The platform as recited in claim 10 wherein the communications network is a proprietary network.

15. The platform as recited in claim 10 wherein the convergent services nodes are also connected via conventional networks, including the Internet, the public switched telephone network, the SS7 signaling network, and the wireless network.

16. The platform as recited in claim 15 further including an external application server wherein at least one of the communications services is provisioned in the external application server and is accessible to the operator via the convergent services nodes in conjunction with the conventional networks.

17. The platform as recited in claim 15 wherein the communications network is distinct from the conventional networks.

18. The platform as recited in claim 10 wherein each of a plurality of service operators is coupled to the platform via the convergent services nodes so that each of the service operators may concurrently provide a plurality of subscribers with a multiplicity of communications services.

19. A method for provisioning a communications service, in conjunction with a platform composed of (a) a plurality of geographically-dispersed convergent services nodes, one of the services nodes serving the service operator; (b) a communication network connected to the nodes; and (c) a database containing information about the service operator, the subscriber, and the communications service provisioned by the platform, the service being requested by a service operator for a subscriber served by the operator, the method comprising
receiving a service request for the communication service by one of the convergent service nodes as transmitted from the service operator via said one of the services nodes, and
provisioning the requested service under the control of at least one of the convergent service nodes.

20. The method as recited in claim 19 wherein the database is distributed and the method further includes maintaining data consistency in the distributed database.
